(19) United States
(12) Patent Application Publication
(10) Pub. No.: US 2008/0279118 A1
(43) Pub. Date: Nov. 13, 2008

(54) SYSTEM AND METHOD FOR PROVIDING SESSION INITIATION PROTOCOL BASED CONFERENCE SERVICE

(76) Inventors: Wook HYUN, Daejeon (KR); Mi Young HUH, Daejeon (KR); Il Jin LEE, Daejeon (KR); Jae Cheon HAN, Daejeon (KR); Shin Gak KANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/962,427

(22) Filed: Dec. 21, 2007

(30) Foreign Application Priority Data
May 11, 2007 (KR) 10-2007-0045983

(51) Int. Cl. H04L 12/16; G06F 15/16

(52) U.S. Cl. 370/260; 709/204

(57) ABSTRACT

A system for providing a session initiation protocol based conference service includes: a conference host terminal that produces requests to setup a call using identification information, to make a registration of participants to be invited to a conference session using a conference identifier, and to initiate the conference session using the conference identifier; a plurality of conference participant terminals as the participants that participate in the conference session; and a conference server having the identification information. The conference server issues the conference identifier to the conference session; stores therein the participant information; and sends to each of the conference participant terminals corresponding to the stored participant information a message to invite the conference participant terminal to the conference session, the message containing the conference identifier, thereby creating the conference session with conference participant terminals which have sent to the conference server acknowledgement messages.

### FIELD OF THE INVENTION

The present invention relates to a system and method for providing an SIP (Session Initiation Protocol) based conference service; and, more particularly, to a system and method for providing an SIP based conference service, which improves user convenience by simplifying creation of a conference session and participation in the conference session.

This work was supported by the IT R&D program of MIC/IITA. [2007-P10-28, Standards Development for MOIP Applications and VoIP interworking]

### BACKGROUND OF THE INVENTION

The SIP is an application-layer signaling protocol which allows intellectual terminals communicating on the Internet to identify and locate with each other and defines procedures for creating, modifying, and terminating multimedia communications sessions therebetween.

Similarly to the HTTP (Hyper Text Transfer Protocol), the SIP works in a transaction processing manner. When a client sends a service request message to a server, the server performs a process in response to the message and sends a response message to the client. Each User communicating by using the SIP uses as an identifier the URI (Uniform Resource Identifier) having a similar form to an email address.

When a conference service, which is a multiparty session, is provided using the SIP, an SIP conference server performs signaling function and a media server mixes voice data received from all terminals to deliver the mixed voice data to the terminals.

To provide the SIP based conference service, an ID of a conference host terminal for use in a conference session (hereinafter, referred to as a “conference host ID”), which differs from an URI of the conference host terminal (hereinafter, referred to as a “conference host URI”), is issued via the DTMF (Dual-tone Multi-frequency) signaling, a web interface, the XCAP (Extensible Markup Language Configuration Access Protocol), or other method than using the SIP. Then, a conference host notifies the conference host ID to conference participants desired to participate in the conference session.

Further, the conference participants use an ID issued to the conference session (hereinafter, referred to as a “conference ID”) to participate in the SIP based conference session which is created by the conference host using the conference host ID.

However, in order to avoid duplication of the conference host ID, the conventional conference host ID is issued in a form of an alpha-numeric random string. Therefore, it is difficult for the conference host to memorize and input the conference host ID.

Further, the conference participants desired to participate in the conference session created using the alpha-numeric random string conference host ID need to be informed the conference ID of the conference session.

### SUMMARY OF THE INVENTION

In view of the above, the present invention provides a system and method for providing an SIP based conference service, which improves user convenience by simplifying creation of a conference session and participation in the conference session.

In accordance with an aspect of the present invention, there is provided a system for providing a session initiation protocol based conference service, the system including:

a conference host terminal that produces requests to setup a call using identification information, to make a registration of participants to be invited to a conference session using a conference identifier, and to initiate the conference session using the conference identifier;

a plurality of conference participant terminals as the participants that participate in the conference session; and

a conference server having the identification information, the server:
issuing, in response to the request to setup the call, the conference identifier to the conference session;
storing therein the participant information; and
sending, in response to the request to initiate the conference session, to each of the conference participant terminals corresponding to the stored participant information a message to invite the conference participant terminal to the conference session, the message containing the conference identifier, thereby creating the conference session with conference participant terminals which have sent to the conference server acknowledgement messages in response to the message to invite the conference participant terminal.

In accordance with another aspect of the present invention, there is provided a method for providing a session initiation protocol based conference service between a conference host terminal and a plurality of conference participant terminals via a conference server, the method including:

requesting from the conference host terminal, to the conference server, to setup a call between the conference host terminal and the conference server, using identification information of the conference server;

issuing, in the conference server, a conference identifier to a conference session to be created in response to the request;

sending from the conference host terminal to the conference server a request to register participant information on participants to be invited to the conference session, using the conference identifier;

registering the participant information in the conference server;

requesting from the conference host terminal to the conference server to initiate the conference session, using the conference identifier;

sending to each of the conference participant terminals corresponding to the registered participant information a message to invite the conference participant terminal to the conference session, the message containing the conference identifier; and

creating the conference session with conference participant terminals which have sent to the conference server acknowledgement messages in response to the message to invite the participant terminal.

In accordance with the present invention, the conference host can make the conference session created without memorizing the alpha-numeric random string conference host ID. Further, by using the conference host URI in place of the conference host ID, the conference participants can participate in the conference session without knowing the conference ID. Therefore, user convenience can be improved.

### BRIEF DESCRIPTION OF THE DRAWINGS

The objects and features of the present invention will become apparent from the following description of embodiments, given in conjunction with the accompanying drawings, in which:

FIG. 1 illustrates a block diagram of a conference service provision system, which issues a conference ID and creates a conference session, in accordance with an embodiment of the present invention;

FIG. 2 illustrates message exchanges in a conference session initiation procedure between a conference host terminal and a conference server in accordance with the present invention; and

FIG. 3 illustrates message exchanges in a conference session participation procedure between conference participant terminals and a conference server in accordance with the present invention.

### DETAILED DESCRIPTION OF THE EMBODIMENTS

Hereinafter, a system and method for providing an SIP based conference service in accordance with embodiments of the present invention will be described in detail with reference to the accompanying drawings.

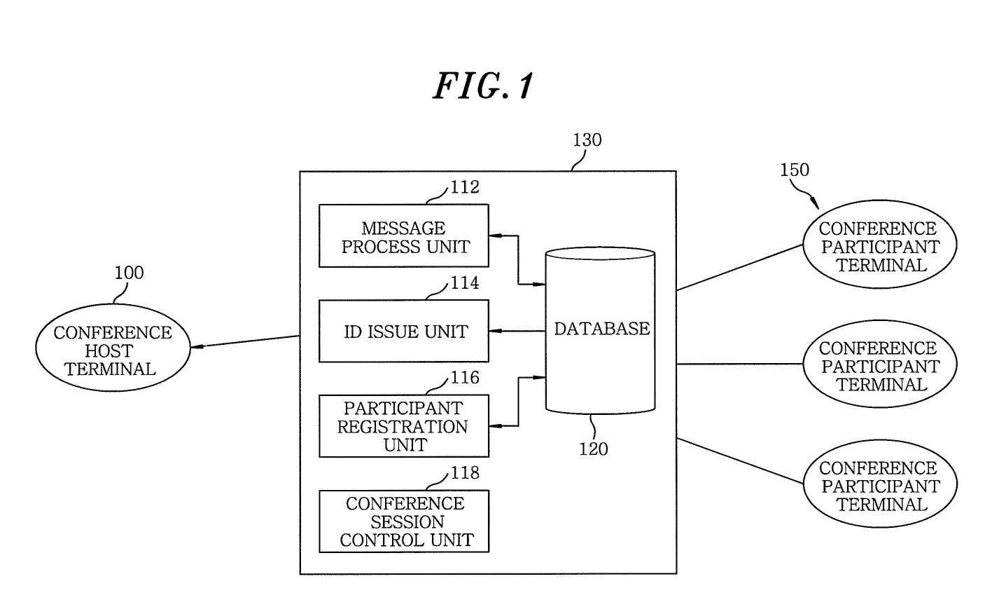

FIG. 1 illustrates an exemplary configuration and environment of an SIP based conference service provision system in accordance with an embodiment of the present invention.

Referring to FIG. 1, the conference service provision system includes a conference host terminal 100; a plurality of conference participant terminals 150; and a conference server 130 which issues a temporary conference ID to a conference session, sends the temporary conference ID to the conference host terminal 100, requests the conference participant terminals 150 selected by the conference host terminal 100 to participate in the conference session, and creates duplex voice channels in response to acknowledgements from the conference participant terminals 150.

The conference host terminal 100 and the conference participant terminals 150 are general SIP terminals, and each terminal may support only six methods or messages INVITE, ACK, BYE, REGISTER, OPTION, and CANCEL among SIP signals defined in RFC (Request for Comments) 3261. According to the present invention, in order to provide a multifunctional conference service to the terminals supporting only the above-described basic methods, the temporary conference ID is issued. Details will be described below.

The SIP standard and RFC 3261 have already been disclosed to be easily applicable to those skilled in the art, and thus description therefor will be omitted.

Each of the conference host terminal 100 and the conference participant terminals 150 inserts to a request message an extension header field, e.g., the Require or Supported header field, having identification information (i.e., information on the request message), and then sends the request message to the conference server 130.

The conference server 130 has a message process unit 112 for processing the received request message based on the identification information of the extension header field therein and sending a response message, e.g., a 2xx or 3xx message, in response to the request message; an ID (identifier) issue unit 114 for issuing a temporary conference ID in response to a first INVITE message to setup a call from the conference host terminal 100; a participant registration unit 116 for registering to a database 120 participant information, which is information on participants of a conference session, received from the conference host terminal 100 via a REGISTER message; and a conference session control unit 118 for creating the conference session after the participants are registered.

Data structure stored in the database 120 includes a conference host URI field, a temporary conference ID field, a temporary conference ID valid time field, and a participant information field.

When receiving from the conference host terminal 100 a second INVITE message to initiate a conference session in which the temporary conference ID is used, the conference session control unit 118 sends third INVITE messages to invite the participants to the conference session, each third INVITE message containing the temporary conference ID, to the conference participant terminals 150 corresponding to the participant information. And then, the conference session control unit 118 creates the conference session with conference participant terminals 150 which have sent acknowledgements to the third INVITE messages.

After that, if the conference session control unit 118 receives a fourth INVITE message to participate in the conference session, in which the conference host URI is used, from a conference participant terminal 150 which has not accepted a call (has not sent the acknowledgement message) at the time of the initiation of the conference session, the conference session control unit 118 sends the temporary conference ID to the conference participant terminal 150. When receiving a fifth INVITE message to participate in the conference session, in which the To field is set as the temporary conference ID, from the conference participant terminal 150 which has not accepted the call at the time of the initiation of the conference session, the conference session control unit 118 allows that conference participant terminal 150 to participate in the conference session.

Further, the conference session control unit 118 terminates the conference session based on the temporary conference ID valid time stored in the database 120.

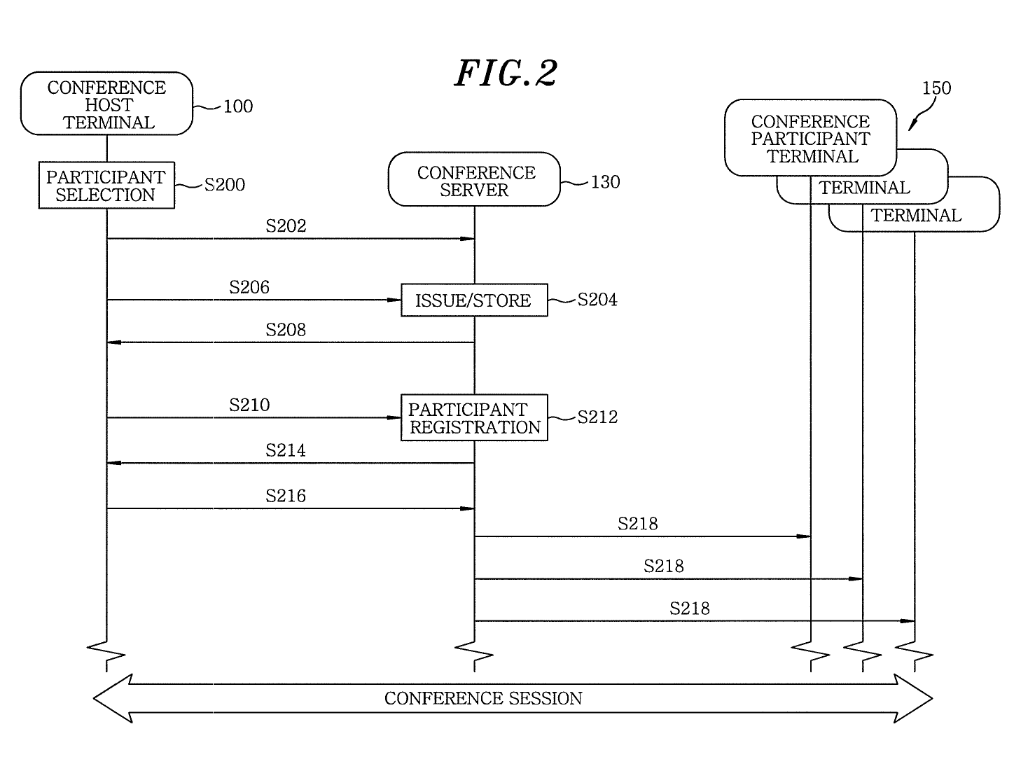

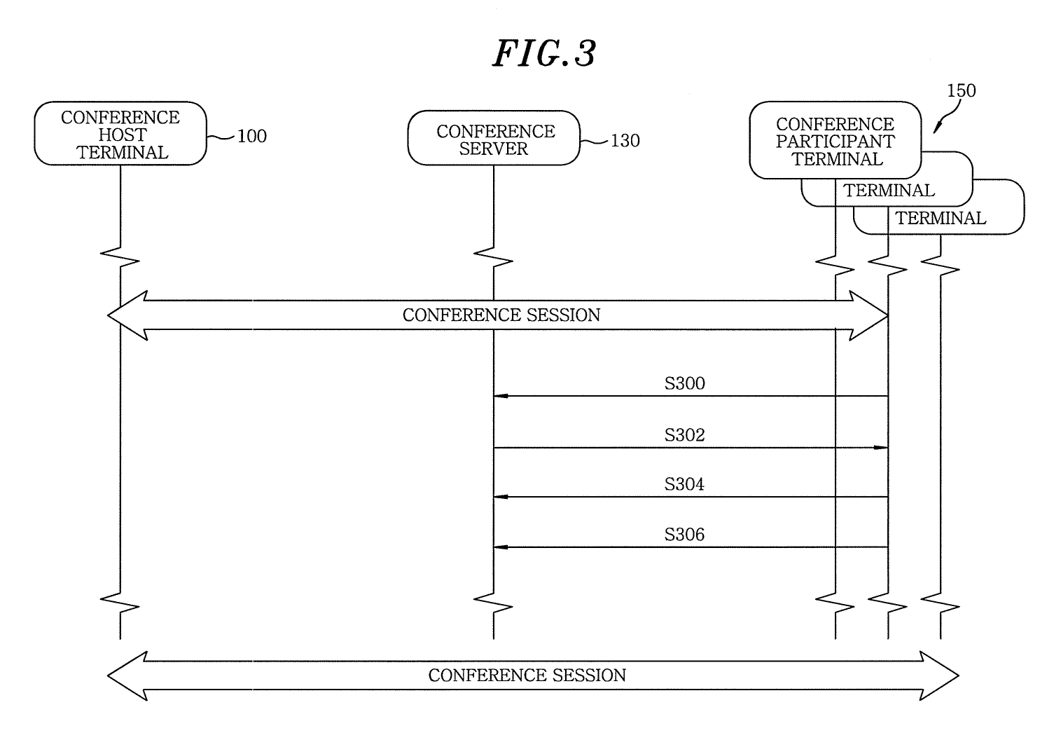

Procedures, performed in a conference service provision system having the above-described configuration, for issuing a temporary conference ID, creating a conference session using the issued temporary conference ID, and participating in the conference session will be described with reference to FIGS. 2 and 3.

FIG. 2 illustrates message exchanges in a conference session initiation procedure between a conference host terminal and a conference server in accordance with the present invention.

Referring to FIG. 2, the conference host terminal 100 selects participants (step S200). That is, the conference host terminal 100 stores in a memory thereof participant information inputted by a conference host.

The conference host terminal 100 sends a first INVITE message to setup a call to the conference server 130 (step S202). Here, the first INVITE message has an extension header, e.g., the Require header, in which identification information is set to inform the conference server 130 that the message is to request an issue of a temporary conference ID. The From header of the first INVITE message is set to a conference host URI, and both the To header and the Request-URI field thereof are set to a conference server URI.

The message process unit 112 determines, based on the extension header and the Request-URI field of the first INVITE message, whether the first INVITE message is to request the issue of the temporary conference ID which is necessary for initiating a conference session. That is, if the first INVITE message has the extension header and the Request-URI field thereof is set to the conference server URI, the message process unit 112 determines that the first INVITE message is to request the issue of the temporary conference ID.

The ID issue unit 114 issues and maps the temporary conference ID with the conference host URI in the first INVITE message. Further, the ID issue unit 114 sets a valid time of the temporary conference ID, and then stores the conference host URI, the temporary conference ID, and the valid time in respective corresponding fields of the database 120 (step S204). The temporary conference ID stored in the database 120 is deleted when the valid time thereof expires.

The ID issue unit 114 sends a 3xx response message to the conference host terminal 100 in response to the first INVITE message (step S206). The Contact header of the 3xx response message includes the issued temporary conference ID, and the Supported header, which is the extension header, includes identification information to notify that the temporary conference ID is sent via the 3xx response message.

The conference host terminal 100 sends an acknowledgement message in response to the 3xx response message (step S208). After that, the conference host terminal 100 sends a REGISTER message having participant information stored in the memory thereof to the conference server 130 (step S210). The Contact header of the REGISTER message includes the participant information, and the extension header thereof includes identification information to notify that the participant information is sent for a registration procedure of a conference service. The From header of the REGISTER message is set to a conference host URI, and the To header thereof is set to the temporary conference ID.

The message process unit 112 determines, based on the identification information of the extension header, whether the REGISTER message is to register participants. If it is determined that the REGISTER message is to register the participants, the participant registration unit 116 stores the participant information in the REGISTER message in the database 120 (step S212), and then sends a 200 response message to the conference host terminal 100 to notify that the participants are registered (step S214).

In response to the 200 response message, the conference host terminal 100 sends to the conference server 130 a second INVITE message to initiate the conference session to which the temporary conference ID is issued (step S216). The second INVITE message includes the temporary conference ID.

In response to the second INVITE message, the conference session control unit 118 checks the validity of the temporary conference ID in the second INVITE message, i.e., determines whether the temporary conference ID exists in the database 120. When it is determined that the temporary conference ID is valid, the conference session control unit 118 sends, using the participant information stored in the database 120, third INVITE messages to invite the participants to the conference session to the conference participant terminals 150 (step S218). After that, the conference session between the conference host terminal 100 and the conference participant terminals 150 is created (step S220). Each of the third INVITE messages sent to the conference participant terminals 150 includes the temporary conference ID.

As described above, in accordance with the present invention, the temporary conference ID is issued and the participant information is registered by using message exchanges between the conference host terminal 100 and the conference server 130, and then the conference session is created by sending to the conference participant terminals 150 messages to invite the participants to the conference session. Therefore, the alpha-numeric random string conference host ID needs not to be memorized by the conference host or known to the conference participants to create the conference session.

FIG. 3 illustrates message exchanges in a conference session participation procedure between conference participant terminals and a conference server in accordance with the present invention.

Hereinafter, a non-participant denotes a participant who has not accepted a call between the conference server 130 and the conference participant terminal 150 thereof when a conference session is created.

If the non-participant has information on a missed call, i.e., the temporary conference ID sent by the conference server 130 when the conference session is created, the non-participant can participate in the conference session by sending to the conference server 130 a fourth INVITE message to participate in the conference session, in which the To field is set as the temporary conference ID, via the non-participant terminal 150.

Meanwhile, if the non-participant does not have information on the missed call, as shown in FIG. 3, the non-participant sends to the conference server 130 a fifth INVITE message to participate in the conference session via the non-participant terminal 150 (step S300).

Here, the Request-URI field of the fifth INVITE message sent by the non-participant terminal 150 is set to the conference server URI, and, the To header and the From header thereof are respectively set to the conference host URI and the non-participant URI.

Further, the fifth INVITE message sent by the non-participant terminal 150 includes an extension header to notify that the non-participant terminal 150 desires to participate in the conference session.

The conference session control unit 118 determines, based on the extension header of the fifth INVITE message, that the fifth INVITE message is to participate in the conference session, and sends a 3xx response message to the non-participant terminal 150 in response to the fifth INVITE message (step S302).

Here, the Contact header of the 3xx response message includes the temporary conference ID.

In response to the 3xx response message, the non-participant terminal 150 sends an ACK message to the conference server 130 to notify the reception of the 3xx response message (step S304). After that, the non-participant terminal 150 sends the fourth INVITE message to the conference server 130 using the temporary conference ID in the 3xx response message (step S306). Accordingly, the non-participant terminal 150 can participate in the conference session.

As described above, in accordance with the present invention, the conference host can make the conference session created or register the participants without using the alpha-numeric random string conference host ID. Also, even if the conference participants do not know the conference host ID, the conference participants can participate in the conference session only by inputting the conference host URI.

Further, call setup request operation to participate in the already created conference session can be mapped with a single button of the non-participant terminal, thereby improving user convenience.

While the invention has been shown and described with respect to the embodiments, it will be understood by those skilled in the art that various changes and modification may be made without departing from the scope of the invention as defined in the following claims.

What is claimed is:

1. A system for providing a session initiation protocol based conference service, the system comprising:
a conference host terminal that produces requests to setup a call using identification information, to make a registration of participants to be invited to a conference session using a conference identifier, and to initiate the conference session using the conference identifier;
a plurality of conference participant terminals as the participants that participate in the conference session; and
a conference server having the identification information, the server:
issuing, in response to the request to setup the call, the conference identifier to the conference session;
storing therein the participant information; and
sending, in response to the request to initiate the conference session, to each of the conference participant terminals corresponding to the stored participant information a message to invite the conference participant terminal to the conference session, the message containing the conference identifier, thereby creating the conference session with conference participant terminals which have sent to the conference server acknowledgement messages in response to the message to invite the conference participant terminal.

2. The system of claim 1, wherein the conference server includes:
an identifier issue unit that issues, in response to the request to setup the call, the conference identifier to the conference session;
a database storing therein the participant information; and
a conference session control unit that sends, in response to the request to initiate the conference session, to each of the conference participant terminals corresponding to the stored participant information the message to invite the conference participant terminal to the conference session, the message containing the conference identifier, thereby creating the conference session with the conference participant terminals which have sent to the conference server acknowledgement messages in response to the message to invite the conference participant terminal.

3. The system of claim 2, wherein the identifier issue unit sets a valid time of the conference identifier and stores the conference identifier and the valid time in the database.

4. The system of claim 3, wherein the conference session control unit terminates the conference session based on the valid time of the conference identifier stored in the database.

5. The system of claim 2, wherein if the conference server receives a message to participate in the conference session using the conference identifier from a conference participant terminal which has not sent the acknowledgement message when the conference session is created, the conference server allows the conference participant terminal to participate in the conference session.

6. The system of claim 2, wherein if the conference server receives a message to participate in the conference session using identification information of the conference host terminal from a conference participant terminal which has not sent the acknowledgement message when the conference session is created, the conference server sends thereto the conference identifier.

7. The system of claim 6, wherein if the conference server receives a message to participate in the conference session using the conference identifier from the conference participant terminal which has not sent the acknowledgement message when the conference session is created, the conference server allows the conference participant terminal to participate in the conference session.

8. The system of claim 2, wherein the identification information of the conference server includes a uniform resource identifier of the conference server.

9. The system of claim 6, wherein the identification information of the conference host terminal includes a uniform resource identifier of the conference host terminal.

10. A method for providing a session initiation protocol based conference service between a conference host terminal and a plurality of conference participant terminals via a conference server, the method comprising:
requesting from the conference host terminal, to the conference server, to setup a call between the conference host terminal and the conference server, using identification information of the conference server;
issuing, in the conference server, a conference identifier to a conference session to be created in response to the request;
sending from the conference host terminal to the conference server a request to register participant information on participants to be invited to the conference session, using the conference identifier;
registering the participant information in the conference server;
requesting from the conference host terminal to the conference server to initiate the conference session, using the conference identifier;
sending to each of the conference participant terminals corresponding to the registered participant information a message to invite the conference participant terminal to the conference session, the message containing the conference identifier; and
creating the conference session with conference participant terminals which have sent to the conference server acknowledgement messages in response to the message to invite the participant terminal.

11. The method of claim 10, wherein the request to setup the call is sent to the conference server via a message and includes identification information to notify that the message is to setup the call and identification information of the conference host terminal.

12. The method of claim 11, wherein the identification information to notify that the message is to setup the call is contained in an extension header of the message.

13. The method of claim 10, wherein the identification information of the conference server includes a uniform resource identifier of the conference server.

14. The method of claim 10, wherein the participant information is pre-stored in a memory of the conference host terminal.

15. The method of claim 10, the method further comprising:
allowing, if the conference server receives a message to participate in the conference session using the conference identifier from a conference participant terminal which has not sent the acknowledgement message when the conference session is created, the conference participant terminal to participate in the conference session.

16. The method of claim 9, the method further comprising:
sending, if the conference server receives a message to participate in the conference session using the identification information of the conference host terminal from a conference participant terminal which has not sent the acknowledgement message when the conference session is created, the conference identifier to the conference participant terminal;
receiving a message to participate in the conference session using the conference identifier from the conference participant terminal; and
allowing the conference participant terminal to participate in the conference session.

17. The method of claim 16, wherein the identification information of the conference host terminal includes a uniform resource identifier of the conference host terminal.
